(19) United States
(12) Patent Application Publication
(10) Pub. No.: US 2020/0317333 A1
(43) Pub. Date: Oct. 8, 2020

(54) DEVICE FOR FLYING WATER-SKI

(71) Applicants: Hiromu NISHIKAWA, Kobe City (JP); Matsuda Yasutoshi Office Inc., Tokyo (JP)

(72) Inventors: Yasutoshi MATSUDA, Tokyo (JP); Hiromu NISHIKAWA, Hyogo (JP)

(21) Appl. No.: 16/326,685

(22) PCT Filed: Sep. 13, 2018
(86) PCT No.: PCT/JP18/34029

§ 371 Date: Feb. 19, 2019

(51) Int. Cl. B64C 33/02; B64C 25/52

(52) U.S. Cl. CPC B64C 33/02; B64C 25/52

(57) ABSTRACT

The present disclosure provides a flying water-ski device which enables a person to float in the air and fly in addition to gliding on the water in waterskiing. The flying water-ski device may be equipped with an airfoil having an outer form of a simplified triangle whose top faces toward the front. A flap section which has right and left flap axes may be placed at the back-end of said airfoil and right and left flaps, each of which can rotate around said right and left flap axes. A suspension support section may be suspended from said airfoil, and a harness section fixed to the suspension support section. A first tow rope may be coupled to the airfoil, and a second tow rope coupled to the harness section.

### FIELD

The present disclosure relates to a device worn by a waterskiier.

### INTRODUCTION

Water-skiing is known as one of the watersports. Though there are various types of water-skiing, generally, a player wears a ski-like device for gliding on his/her both legs and grips a handle of the tip of a rope coupled with a tugboat such as a motorboat, and glides through on the water surface being towed by a tugboat navigating at the speed of several dozen km/h. (Refer to Non-patent Document 1.)

Air sports such as hang gliders, paragliders, which a person can float in the air or glide through the air using wind, instead of using power, are also known. (Refer to Patent Document 1.)

### PRIOR ART DOCUMENT

### Patent Document

Patent Document 1: Japanese Unexamined Patent Application Publication No. 2001-30998.

### Non-Patent Document

Non-patent Document 1: http://jwsa.jp/ (Website of NPO Japan Waterski and Wakeboard Federation)

### SUMMARY

### Problems to be Solved

In water-skiing, basically, a player glides through on the water. In water-skiing, other than a player glides through on the water, it has not been conducted by a player to float in the air and fly, and further, a device which enables a player to fly has not been presented yet.

Considering the current situation stated above, the present disclosure provides a flying water-ski device which enables a player to float in the air and fly in addition to his/her gliding through on the water surface.

### Devices for Solving the Problems

To achieve the above purpose:
In the mode of the present disclosure, this is a flying water-ski device used for a player to float in the air from the water surface and to fly, in water-skiing in which a player glides through on the water surface by being towed, and the device is characterized by being equipped with:

(a) an airfoil having an airfoil frame with an outer form of a simplified triangle with its top facing toward the front and an airfoil cloth stretched on said airfoil frame,

(b) right and left flap axes set at the back-end of said airfoil and a flap section which has right and left flaps, each of which can rotate around said right and left flap axes,

(c) a suspension support section suspended from said airfoil, (d) a harness section fixed to said suspension support section and having a plurality of belts for a player to wear,

(e) a first tow rope connected to said airfoil, and a second tow rope connected to said harness section.
In the above mode, it is preferable that each of right and left handles, which a player can grasp in order for him/her to control each rotating position of said right and left flaps, are designed to be suspended from said airfoil.
In the above mode, it is preferable that when a player moves each of said right and left handles in the upward and downward directions, each of said right and left flaps will rotate.
In the above mode, it is preferred that one or a plurality of safety device are set enabling that when a prescribed tension is applied to each of said first and second tow ropes, each of the ropes can be separated at the middle position or removed from the connected sections.
In the above mode, it is preferred that said airfoil has a tail on its upper side.
In the above mode, it is preferred that said harness section has a cushion material at the position which physically contacts the back of a player.

### Effects

The present disclosure enables a waterski player to float in the air and fly while water-skiing and to feel more refreshed.

### BRIEF DESCRIPTION OF THE DRAWINGS

FIG. 1 is a side view showing an outline of the using method of the flying water-ski device (while gliding through on the water surface) according to the present disclosure.

FIG. 2 is a side view showing an outline of the using method of the flying water-ski device (while flying) according to the present disclosure.

FIG. 3 is a 2D diagram outlining the flying water-ski device.

FIG. 4 is a left side view outlining the flying water-ski device.

FIG. 5 is a front view outlining the flying water-ski device.

FIG. 6 is a back view outlining the flying water-ski device.

FIG. 7 (a) (b) are diagrams schematically showing configuration examples for the control of the flaps.

FIG. 8 (a) (b) are diagrams showing examples of the safety device to be mounted on the tow ropes.

### DETAILED DISCLOSURE

By referring to the drawings which show examples of the implementation of the present disclosure, embodiments of the present disclosure are explained below:

The device for flying water-ski of the present disclosure is a device which a player who does waterskiing wears. As mentioned above, this is a new device, since the device which enables a player to float in the air and fly while he/she is waterskiing has not been presented before. Accordingly, prior to providing explanations of the configuration of the device, first, the usage of the device is explained below.

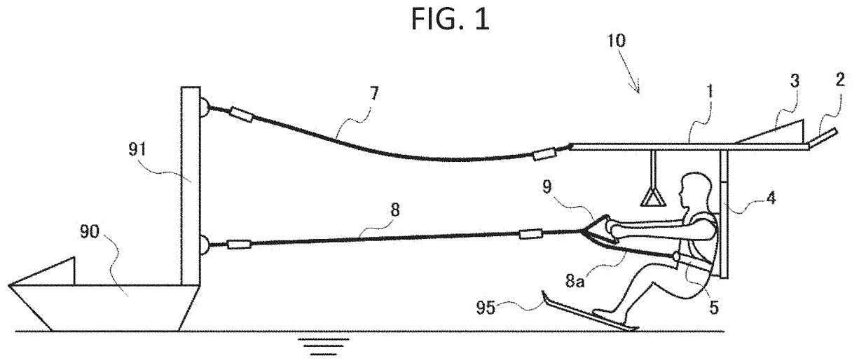

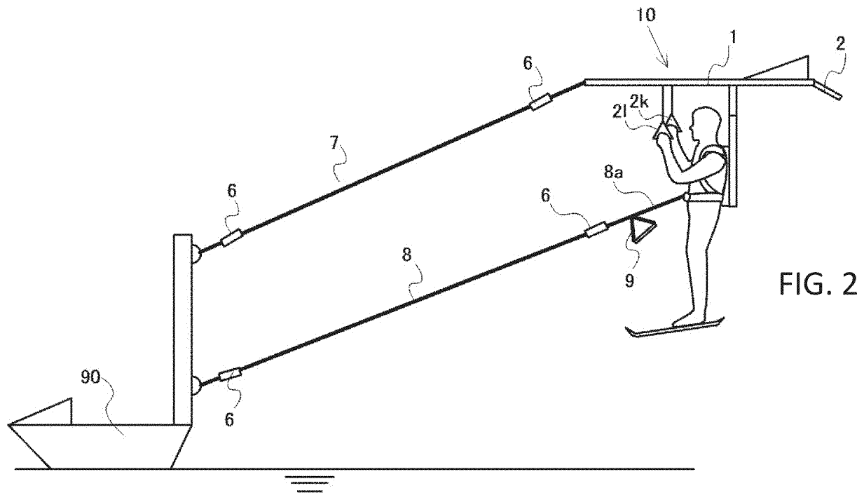

FIGS. 1 and 2 are side views outlining the usage of the flying water-ski device according to the present disclosure.

FIG. 1 shows a status of a player who is gliding through on the water towed by a motorboat 90. The player wears a plate-like slider 95 for normal water-skiing on both legs. Further, an appropriate tow rack 91 is set at the motorboat 90 for coupling one end of a tow rope 8. By gripping a handle 9 by hands connected to the vicinity of the other end of the tow rope 8, the player is towed by the motorboat 90 and can glide through on the water. This situation is exactly the same as the usual water-skiing. It should be noted that the tow rope 8 has an extension part 8a from the connection point of the handle 9.

In FIG. 1, the player wears a flying water-ski device 10 according to the present disclosure. The player wears the device 10 for flying water-ski (hereinafter simply called “the device 10”) by shouldering it on the back like a backpack. The device 10 has an airfoil 1 with a simplified triangle-shaped kite-like form for catching a wind; a flap section 2 for adjusting a lifting power; a tail unit 3 on the upper side of the airfoil 1; a suspension support section 4 suspended from the airfoil 1; and a harness section 5 for the player to wear.

The airfoil 1 has the flap section 2. Flaps, the main component of the flap section 2, are set at the back end of the airfoil 1, and can be rotated around the flap axes in line with the back end of the airfoil 1. Depending on the rotating position, i.e. the direction, of the flaps, a lifting power put on the device 10 can be adjusted. Accordingly, depending on the direction of the flaps, the player can ascend into the air or descend onto the water surface. The player can control the direction of the flaps by operating the device, details of which are described later. While in the state of gliding through on the water as shown in FIG. 1, the direction of the flaps is in the position where a lifting power does not generate (up toward the backward) so that the player can stably glide through on the water.

An end of a tow rope 7 is coupled to the front end of the airfoil 1, and the other end of the tow rope 7 is coupled to the tow rack 91 of the motorboat 90. Further, to the harness section 5, an end of the extended part 8a of the tow rope 8 is coupled. In the state of gliding through on the water as shown in FIG. 1, the tow rope 7 and the extended part 8a of the tow rope 8 are slack; The tow rope 8 except for the extended part 8a comes under tension.

FIG. 2 shows the state of the player being towed by the motorboat 90 and being floated in the air and flying. After the player has reached the appropriate speed while water-skiing shown in FIG. 1, he will switch his both hands from the handle 9 to right and left handles 2k, 2l for operation of the flap section 2. By switching the handles, the entire tow tope 8 including the extended part 8a will come under tension. In the same manner, the tow tope 7 will come under tension. Subsequently, the player maneuvers the handles 2k, 2l so that the flaps of the flap section 2 will rotate. By such action, the flaps are in the position which generate a lifting power (downward toward the backward). With the lifting power put on the airfoil 1, the device 10 can be lifted in the air together with the player.

With this action, the player can be lifted in the air, and can fly towed by the motorboat 90 via the tow rope 7 and the tow rope 8. In order to fly steadily, it is preferable that the tow rope 7 and the tow rope 8 are approximately in parallel while flying. In order to realize such state, the length of the tow ropes 7 and 8 and the coupled position of the tow ropes 7 and 8 to the motorboat 90 should appropriately be set.

Preferably, in each of the tow ropes, one or a plurality of safety device is inserted in the middle position, which allows each of the tow ropes to be separated at the middle position when a tension exceeding a certain threshold is applied. In the example shown in FIG. 2, pieces of the safety device 6 are set at two places; the position close to the motorboat 90, and the position close to the device 10, in each of the tow ropes 7 and 8.

Though there is no diagram provided here, as another example, the safety device 6 can be set at the coupled part of the motorboat 90 or the device 10 to which each end of the tow ropes 7, 8 is coupled. In such case, when a tension which exceeds a certain threshold is applied, the tow ropes 7, 8 are to be removed from the coupled part.

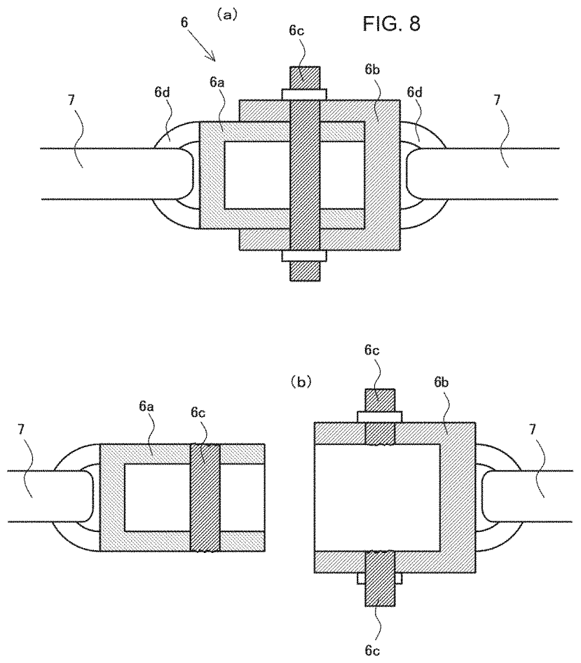

For such safety device 6, for example, a configuration (exemplified in FIG. 8) can be made wherein a shear pin is used which is to be broken when subjected to a certain shear power.

The player can make a turn in a clockwise direction and an anti-clockwise direction by maneuvering the handles 2k, 2l. Further, the player can descend on the water surface again by operating the handles 2k and 2l. In addition, the player can do water-skiing again by switching from the handles 2k, 2l to the handle 9 on the tow rope 8. The above explanations will be detailed later.

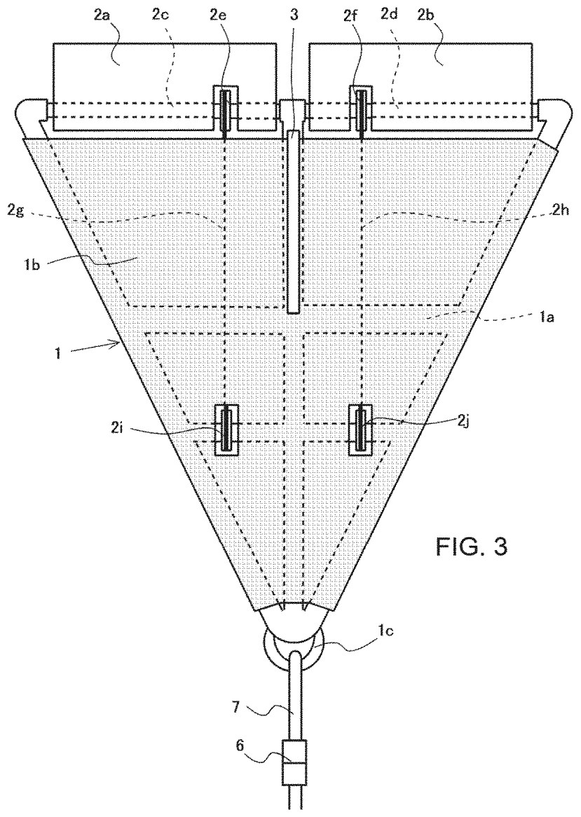

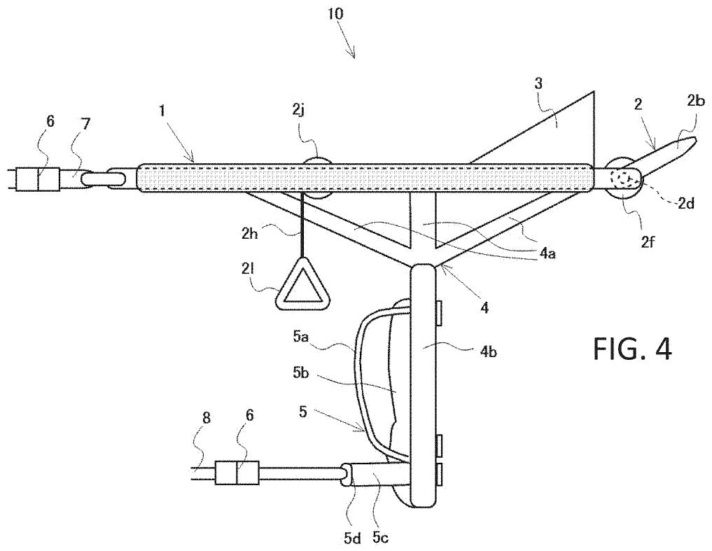

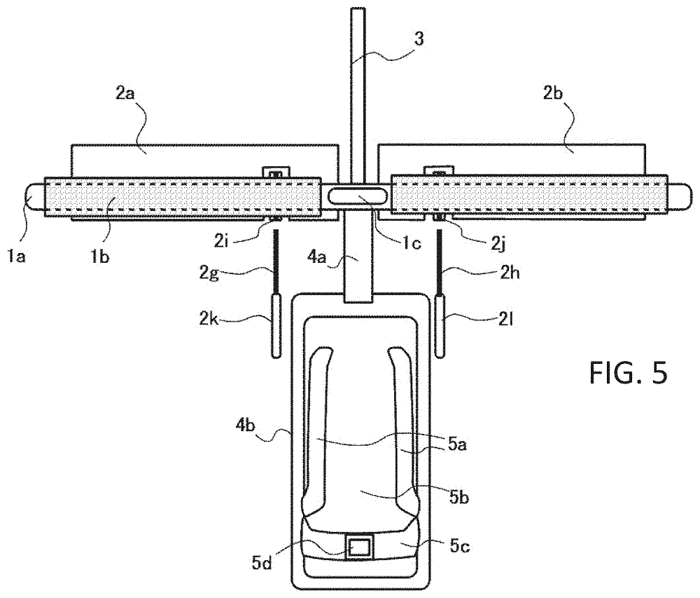

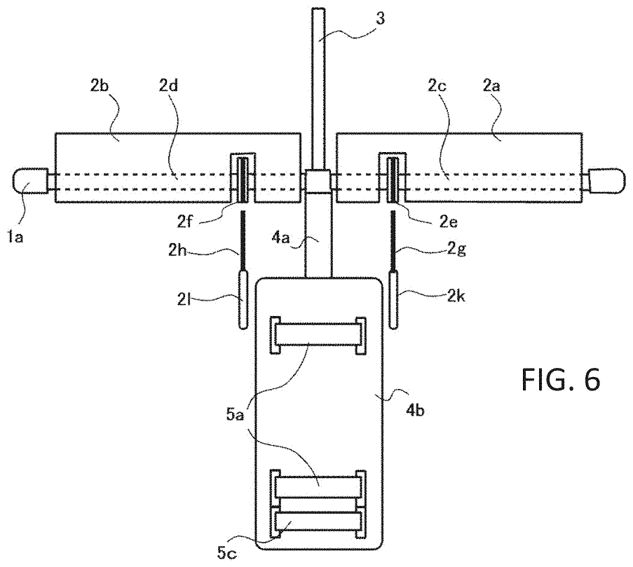

By referring to a practical example shown in FIGS. 3-6, explanations on the configuration of the device 10 for flying water-ski shown in FIG. 1 and FIG. 2 are given. FIG. 3 is the 2D diagram outlining the flying water-ski device. FIG. 4 is the left side view outlining the flying water-ski device. FIG. 5 is the front view outlining the flying water-ski device. FIG. 6 is the back view outlining the flying water-ski device.

The 2D diagram of FIG. 3 is shown with the lower side of the figure being the forward direction, and with the upper side being the backward direction. The airfoil 1 of the device 10 has an airfoil frame 1a and an airfoil cloth 1b stretched in the airfoil frame 1a.

The airfoil frame 1a is shaped like a simplified triangle with the top facing in the forward direction, preferably, it is shaped like a simplified isosceles triangle, and has a framework supporting the entire airfoil 1. In the airfoil frame 1a, in addition to the frame material constituting each side of the triangle, at least a frame material connecting the top of the triangle and the center of the bottom of the triangle are placed. Further, in accordance with the required strength, one or a plurality of frame materials in the lateral direction are set up. In such frame materials, it is preferable that metallic pipe materials, which are light and with a strong intensity, such as aluminum or titanium, are used as a core, and such core is covered by flexible materials such as urethane foam.

As with the airfoil frame 1a, the airfoil cloth 1b, equipped with the outer form of a simplified triangle, preferably with a simplified isosceles triangle, is set up to cover the entire airfoil frame 1a. The airfoil cloth 1b is fixed with certainty to the airfoil frame 1a, at least in the two lateral sides of the triangle, and preferably, fixed with certainty to the airfoil frame 1a on the centerline. As a way of fixing the airfoil cloth 1b to the airfoil frame 1a, for example, a hook and loop fastener can be used. For instance, forming a space for the hook and loop fastener on the marginal parts of the airfoil cloth 1b and twisting such hook and loop fastener to the airfoil frame 1a to fix. Since the hook and loop fastener is detachable, it is preferable to use. As another example, the airfoil cloth 1b may be fixed to the airfoil frame 1a permanently.

The airfoil cloth 1b is made of materials which are light, and with a durability and weather resistance, also used for glider aircrafts such as paragliders, hang gliders. As the composition of the cloth, fabric, knit fabric, bonded-fiber fabric, or any combination of these fabrics may be acceptable, and a laminated body structure is preferable. As materials of the cloth, resinoid, such as polyester, polyamide, polypropylene, acrylic acid ester, chloroethylene, vinylidene chloride, or natural fiber may be used.

It is preferable to set the tail 3 on the upper surface in the vicinity of the backend of the airfoil 1. The tail 3 is a vertical tail, and for instance, formed like a triangle with an ascending inclination toward the backward. The tail 3 has an effect of controlling an unintentional rotation to rightward and leftward, and stabilizing the flying.

At the top of the triangle of the airfoil 1, a connection section 1c is set to couple the first tow rope 7.

Right and left flaps 2a, 2b of the flap section 2 are set at the backend of the airfoil 1. The flaps 2a, 2b are set symmetrically on the centerline of the triangle of the airfoil 1. The flaps 2a and 2b are set in a way that they can be rotated around flap axes 2c, 2d, respectively. In the example shown in the diagram, the configuration is adopted in which the flaps 2a and 2b rotate together with the flap axes 2c, 2d, respectively. In the example shown in the diagram, the flap axes 2c, 2d are convertible with the materials which constitute the base of the triangle of the airfoil frame 1a. As for the configuration in which the flap axes 2c, 2d themselves are rotated, bearings (no diagram is provided) will support both ends of the flap axes 2c, 2d. As another example, the configuration can be adopted in which the flap axes 2c, 2d are fixed and only the flaps 2a, 2b are rotated.

The flaps 2a and 2b are made of a plate-like material in a substantially rectangular shape. The length of the flaps 2a and 2b in the axis direction are longer than that in the vertical direction. As with the flaps of an airplane, the flaps 2a and 2b play the role of adjusting a lifting power put on the device 10. Though the shape of the flaps 2a and 2b could be a streamline shape like the flaps of an airplane, a flat-plate shape with an almost even thickness is preferred; This prevents from overflying taking the safety into consideration.

The flap section 2 is equipped with a mechanism allowing the player to manually control the respective rotate position of the flaps 2a, 2b. As an example, this mechanism has right and left rear pulleys 2e, 2f which rotate together with the flap axes 2c, 2d; right and left operation cords 2g, 2h; right and left front pulleys 2i, 2j mounted on the appropriate position of the airfoil frame 1a; and the right and left handles 2k, 2l shown in FIG. 1. The back end of the operation cords 2g, 2h are coupled to the axis of the rear pulleys 2e, 2f, respectively. The front end of the operation cords 2g, 2h are coupled to the handles 2k, 2l via the front pulleys 2i, 2j. For instance, pulling down the right handle 2k will pull the operation cord 2g forward, and the rear pulley 2e will rotate, and in line with such action, the flap axis 2c and the flap 2a will rotate. Pulling down the left handle 2l will pull the operation cord 2h forward, and the rear pulley 2f will rotate, and in line with such action, the flap axis 2d and the flap 2b will rotate. The above explanations will be detailed later.

As shown in the left side view in FIG. 4, the device 10 has a suspension support section 4 suspended from the airfoil 1 on the underside of the airfoil 1. The suspension support section 4 plays the role of coupling the harness 5 directly worn by the player and the airfoil 1. The mechanism of the suspension support section 4 can be varied. In the example shown in the diagram, it comprises a plurality of coupling frame 4a coupled to the airfoil frame 1a of the airfoil 1; and a harness fixing frame 4b, extended on the lower side of the coupling frame 4a, to which the harness section 5 is mounted. The connecting frame 4a and the harness fixing frame 4b can be formed by pipe materials, such as aluminum or titanium, covered by a flexible material such as urethane foam, or angle bar, etc.

The harness section 5, for instance, has a shoulder belt 5a through which the player puts his/her both arms; a cushion material 5b which directly contacts the back of the player; and a hip belt 5c which is put around the hip of the player. As shown in the back view of FIG. 6, as an example, the shoulder belt 5a and the hip belt 5c are get past through the back of the harness fixing frame 4b in the traverse direction via the hole made in the simplified plate-like harness fixing frame 4b. In this structure, the shoulder belt 5a and the hip belt 5c are strongly fixed to the harness fixing frame 4b.

At the center of the front side of the hip belt 5c, a coupling section 5d which couples the second tow rope 8 is set.

Though no diagram is provided here, the harness section 5 may have a leg belt through which the player puts his/her both legs. With this function, the player can be supported more stably.

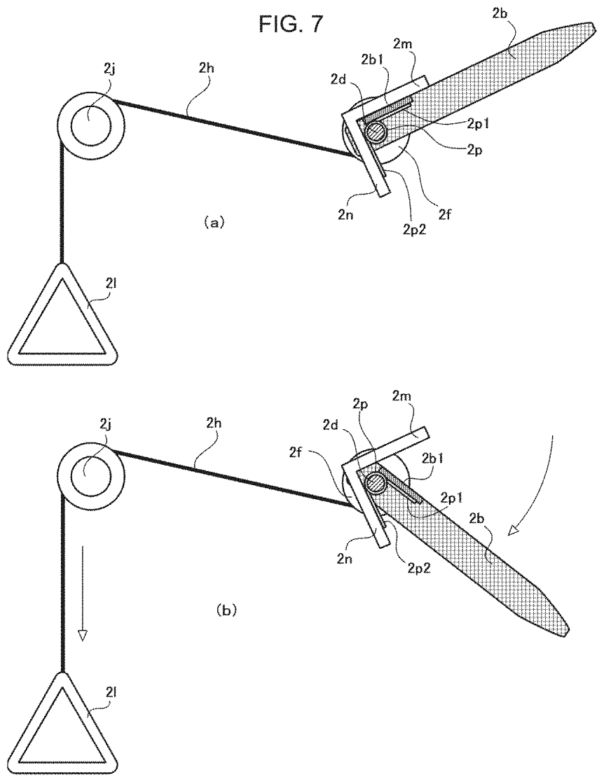

By referring to FIG. 7, explanations are given on an example of the mechanism enabling the player to manually control the rotation position of the flap 2a, 2b. As FIG. 7 is a schematic diagram to show the principle, the actual relative dimension and relative positional relationship of each composition element are not reflected in the diagram. In FIG. 7, an explanation is given using the left flap 2b as an example. There are cases that explanations given below refer to marks in each diagram mentioned above.

FIG. 7(a) shows the default position of the flap 2b. The default position is the position of the flap 2b when the player does not apply force on the handle 2l.

A helical spring 2p is mounted on the surrounding of the flap axis 2d. In the flap 2b, a plate-like protrusion 2b1 protruded in the horizontal direction as part of the flap 2b in parallel with the upper surface is formed. Further, two fixed walls 2m, 2n are set which regulated the rotation range of the flap 2b. The fixed walls 2m, 2n are formed, for instance, united with the airfoil frame 1a, and immobile.

As described above, the flap 2b and the flap axis 2d and the rear pulley 2f rotate all in one. The rear pulley 2f and the handle 2l are connected by the operation cord 2h which goes through the front pulley 2j. The rear pulley 2f has a drum-like axis with a prescribed diameter. An end of the operation cord 2h is fixed to that drum-like axis. Further, after the operation cord 2h is winded with the drum-like axis of the rear pulley 2f for more than a prescribed turns, the cord is veered out to the front pulley 2j. At the default position, the operation cord 2h is winded most with the rear pulley 2f. Therefore, at the default position, the handle 2l is in the top position.

A leg 2p1, a leg of the helical spring 2p engages in the plate-like protrusion 2b1 of the flap 2b. The other leg 2p2 of the helical spring 2p engages in the fixed wall 2n. The leg 2p1 is biasing the plate-like protrusion 2b1 in the anti-clockwise direction, and the leg 2p2 is biasing the fixed wall 2n in the clockwise direction.

At the default position, although the leg 2p1 of the helical spring 2p is biasing the plate-like protrusion 2b1 in the anti-clockwise direction, the plate-like protrusion 2b1 cannot rotate any further because of the fixed wall 2m. This position is the limit position of the flap 2b in the anti-clockwise direction.

Accordingly, at the default position where the player does not apply force on the handle 2l, the flap 2b is in the position with an ascending inclination toward the backward. In this status, when a wind blows from forward to backward, the upper side of the flap 2b will receive a wind pressure. As a result, a force to pull down the flap 2b will work.

For instance, when the player does not apply force on any of the right and left handles, the force to pull down the both flaps will work, which inhibits a floating of the device 10; This means that the player will not float against his/her intention and will be able to stay on the water surface.

Next, FIG. 7 (b) shows the position of the flap 2b when the player pulls down the handle 2l by applying force. When the handle 2l is pulled downward, the operation cord 2h twined around the rear pulley 2f is veered out from the drum axis of the rear pulley 2f and the rear pulley 2f rotates. In line with the rotation of the rear pulley 2f, the flap axes 2d and the flap 2b rotate as indicated by arrows, i.e. in the clockwise direction. The rotation is conducted by the plate-like protrusion 2b1 resisting the energizing force of the helical spring 2p, pushing down the leg 2p1. The position of the leg 2p2 will not change as it is regulated by the fixed wall 2n.

The setting is made in which the operation range of the handle 2l in the upward and downward direction and the rotation range of the flap 2b should correspond appropriately. The manageable operation range of the handle 2l is, for example, 20 to 30 cm. In line with such operation range, the setting is made in which the flap 2b can rotate in the rear direction within the range between 20 degrees upward and 30 degrees downward. However, these ranges are an example, and it is not limited to such ranges. This kind of corresponding relationship can be established, for instance, by setting appropriately the diameter of the drum axis of the rear pulley 2f.

Accordingly, pulling down the handle 2l by the player will lower the flap 2b to the position with a descending inclination toward the backward. In this status, when a wind blows from forward to backward, the lower side of the flap 2b will receive a wind pressure. As a result, a force to pull up the flap 2b, i.e. a lifting power will work.

For instance, when the player pushes downward both right and left handles at the same time, with a lifting power applying onto both flaps, the device 10 will float. By aligning the length of pulling the right and left flaps, the player can fly heading in a straight line. While flying, the airfoil 1b of the airfoil 1 receives a wind pressure from under.

Further, for example, when the player pushes downward the left handle 2l only, the left flap 2b will go downward, and with the right flap 2a going up, a lifting power will apply only to the left flap 2b. As a result, the device 10 will turn in the right direction. Conversely, when the player pushes the right handle 2k downward, the right flap 2a will go downward and with the left flap 2b going up, a lifting power will apply only to the right flap 2a. As a result, the device 10 will turn in the left direction.

In this way, the player can ascend, turn right and left and descend by manual operation. The mechanism shown in FIG. 7 is an example, and the mechanism of manual operation of the flying water-ski device of the present disclosure is not limited to such mechanism.

FIG. 8 is a diagram showing an example of the safety device mounted on the tow rope. Here, explanations are given taking the case of the safety device 6 inserted at the middle position of the tow rope 7 as an example.

FIG. 8 (a) shows a cross-sectional view outlining the near-field region including the safety device 6 in a normal usage state. The safety device 6 has two components 6a, 6b and a shear pin 6c to combine the components 6a, 6b. The two components 6a, 6b are both a cylindrical member with one end being open and the other end being closed. A coupled part 6d to couple the tow rope 7 is provided on each of the closed end of the components 6b, 6b and the end of the tow rope 7 is coupled.

As the outer diameter of the component 6a and the inner diameter of the component 6b are almost the same, the open end of the component 6a and that of the component 6b can be fit together by facing them. In cylinder walls of each of the component 6a, 6b, a hole through which the shear pin 6c can be pierced in the diametrical direction is formed. With the component 6a being inserted in the component 6b, the shear pin 6c is pierced in the holes of the components 6a, 6b in order for the shear pin 6c to be appropriately fixed. The shear pin 6c is selected to break when a shear force exceeding a certain threshold is applied.

FIG. 8(b) is a cross-sectional view outlining the status in which a tension exceeding a certain threshold is applied to the tow rope 7. When a tension beyond a certain threshold is applied to the tow rope 7, the shear pin 6c is broken by the shear force, and the components 6a and 6b are to be separated.

The safety device shown in FIG. 8 can be provided not only at the middle position of the tow rope, but also, in the same manner, at the coupled section of the motorboat or the flying water-ski device.

The specific configuration of the flying water-ski device described above is one example, and there could be various forms of examples within the range that are included in the main scope of the present disclosure.

### REFERENCE NUMERALS

1 Airfoil
1a Airfoil frame
1b Airfoil cloth
1c Coupling section for tow rope
2 Flap section
2a Right flap
2b Left flap
2c Right flap axis
2d Left flap axis
2e Right rear pulley
2f Left rear pulley
2g Right operation cord
2h Left operation cord
2i Right front pulley
2j Left front pulley
2k Right handle
2l Left handle
3 Tail
4 Suspension support section
4a Coupling frame
4b Harness fixing frame
5 Harness section
5a Shoulder belt
5b Cushion material
5c Hip belt
5d Coupling section for tow rope
6 Safety device
7, 8 Tow ropes (for flying)
9 Handles (for waterski)
90 Motorboat
91 Tow rack

The series of paragraphs below recites various illustrative combinations of features of the present disclosure. These paragraphs are intended to represent a non-limiting presentation of suitable combinations, and are alphanumerically designated for clarity and efficiency:

A0. A device for flying water-ski which enables a person to float in the air and fly in addition to gliding through on the water in waterskiing.

B0. In waterskiing in which a player glides through on the water by being towed, this is a device for flying water-ski for the player to float in the air from the water surface and fly, and equipped with an airfoil having an airfoil frame with an outer form of a simplified triangle whose top facing toward the front and an airfoil cloth stretched at the said airfoil frame; a flap section which has right and left flap axes placed at the back-end of said airfoil and right and left flaps, each of which can rotate around said right and left flap axes; a suspension support section suspended from said airfoil; a harness section fixed to said suspension support section and having a plurality of belts for a player to wear; and a first tow rope coupled to said airfoil, and a second tow rope coupled to said harness section.

C0. A device for flying water-ski to be used to float from the water surface and fly above in waterskiing in which the player is towed and glided through on the water, characterized by being comprised of:

(a) an airfoil having an airfoil frame with an outer form being a simplified triangle whose top facing toward the front and an airfoil cloth stretched at the said airfoil frame,
(b) right and left flap axes set at the back-end of said airfoil and a flap section which has right and left flaps, each of which can rotate around the said right and left flap axes,
(c) a suspension support section suspended from the said airfoil,
(d) a harness section fixed to said suspension support section and having a plurality of belts for a player to wear,
(e) a first tow rope coupled to said airfoil, and a second tow rope to be coupled to said harness section.
C1. The device for flying water-ski of C0, characterized in that each of right and left handles, which a player can grasp in order to control the rotating position of each of said right and left flaps, are suspended from said airfoil.

C2. The device for flying water-ski of C1, characterized in that when the player moves each of said right and left handles in the upward or downward directions, each of said right and left flaps rotates.

C3. The device for flying water-ski of any one of C0 through C2, characterized in that one or a plurality of safety device are set enabling that when a prescribed tension is applied to each of said first and second tow ropes, each of the ropes can be separated at the middle position or be removed from the coupled section.

C4. The device for flying water-ski of any one of C0 through C3, characterized in that said airfoil has a tail on its upper side.

C5. The device for flying water-ski of any one of C0 through C4, characterized in that said harness section has a cushion material at the position which physically contacts the back of a player.

1. A flying water-ski device to be used to float from the water surface and fly above when waterskiing, of the device comprising:
(a) an airfoil having an airfoil frame with an outer form being a simplified triangle whose top faces forward and an airfoil cloth stretched on the said airfoil frame,
(b) right and left flap axes set at a back-end of the airfoil and a flap section which has right and left flaps, each of which is configured to rotate around a corresponding one of the right and left flap axes,
(c) a suspension support section suspended from the airfoil,
(d) a harness section fixed to the suspension support section and having a plurality of belts for a player to wear,
(e) a first tow rope coupled to the airfoil, and a second tow rope configured to be coupled to the harness section.

2. The flying water-ski device of claim 1, wherein the right and left handles, each of which is configured such that a player can grasp in order to control a rotating position of a corresponding one of the right and left flaps, are suspended from the airfoil.

3. The flying water-ski device of claim 2, wherein when the player moves each of the right and left handles in an upward or a downward direction, a corresponding one of each of the right and left flaps rotates.

4. The flying water-ski device of claim 1, further comprising one or more safety devices, set such that when a prescribed tension is applied to each of the first and second tow ropes, each of the ropes can be separated at the middle position or be removed from the coupled section.

5. The flying water-ski device of claim 1, wherein an upper side of the airfoil comprises a tail.

6. The flying water-ski device of claim 1, wherein the harness section has a cushion material at a position which physically contacts the back of the player.

7. The flying water-ski device of claim 2, further comprising one or more safety devices, set such that when a prescribed tension is applied to each of the first and second tow ropes, each of the ropes can be separated at the middle position or be removed from the coupled section.

8. The flying water-ski device of claim 2, wherein an upper side of the airfoil comprises a tail.

9. The flying water-ski device of claim 2, wherein the harness section has a cushion material at a position which physically contacts the back of the player.

10. The flying water-ski device of claim 3, further comprising one or more safety devices, set such that when a prescribed tension is applied to each of the first and second tow ropes, each of the ropes can be separated at the middle position or be removed from the coupled section.

11. The flying water-ski device of claim 3, wherein an upper side of the airfoil comprises a tail.

12. The flying water-ski device of claim 3, wherein the harness section has a cushion material at a position which physically contacts the back of the player.

13. The flying water-ski device of claim 4, wherein an upper side of the airfoil comprises a tail.

14. The flying water-ski device of claim 4, wherein the harness section has a cushion material at a position which physically contacts the back of the player.

15. The flying water-ski device of claim 5, wherein the harness section has a cushion material at a position which physically contacts the back of the player.
